(19) United States
(12) Patent Application Publication
(10) Pub. No.: US 2007/0065637 A1
(43) Pub. Date: Mar. 22, 2007

(54) Carrier with anisotropic wetting surfaces

(76) Inventors: Charles W. Extrand, Minneapolis, MN (US); Micheal Wright, Greenwood, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/228,897

(22) Filed: Sep. 16, 2005

(51) Int. Cl. G11B 5/64

(52) U.S. Cl. 428/141

(57) ABSTRACT

A carrier with anisotropic wetting surfaces for promoting more effective cleaning and drying of the carrier. In the invention, entire surfaces or portions of surfaces of a carrier are made to effect anisotropic wetting. In the invention, entire surfaces or portions of surfaces of a carrier are made to effect anisotropic wetting so that fluids flow off of the surface readily in a desired draining orientation. Surfaces having anisotropic wetting qualities can be used to ensure that small droplets of liquid drain fully from the surface or, alternately, can be used to help ensure that droplets are retained in areas where when they dry any contaminants are unlikely to cause harm.

### FIELD OF THE INVENTION

The present invention relates generally to carriers for delicate electronic components, and more particularly to a carrier having drainable surfaces formed thereon.

### BACKGROUND OF THE INVENTION

The process of forming semi-conductor wafers or other delicate electronic components into useful articles requires high levels of precision and cleanliness. As these articles become increasingly complex and miniaturized, contamination concerns grow. Contamination problems reduced by providing controlled fabrication environments known as “clean rooms”. Such clean rooms are protected from chemical and particulate contamination to the extent technically and economically feasible.

While clean rooms substantially remove most contaminants found in ambient air, it is often not possible or advisable to completely process components in the same clean room environment. Moreover, not all contamination and contaminants are eliminated. For that and other reasons, delicate electronic components are transported, stored, and fabricated in bulk using protective carriers. Examples of specialized carriers are disclosed in U.S. Pat. Nos. 6,439,984; 6,428,729; 6,039,186; 6,010,008; 5,485,094; 5,944,194; 4,815,601; 5,482,161; 6,070,730; 5,711,427; 5,642,813; and 3,926,305, all assigned to the owner of the present invention, and all of which are hereby fully incorporated herein by reference. For the purposes of the present application, the term “carrier” includes, but is not limited to: semiconductor wafer carriers such as H-bar wafer carriers, Front Opening Unified Pods (FOUPs), and Standard Mechanical Interface Pods (SMIFs); reticle carriers; and other carriers used in the micro-electronic industry for storing, transporting, fabricating, and generally holding small electronic components such as hard drive disks and other miscellaneous mechanical devices.

Contamination and contaminants can be generated in many different ways. For example, particulates can be generated mechanically by wafers as they are inserted into and removed from wafer carriers, and as doors are attached and removed from the carriers, or they can be generated chemically in reaction to different processing fluids. Contamination can also be the result of out-gassing on the carrier itself, biological in nature due to human activity, or even the result of improper or incomplete washing of the carrier. Contamination can also occur on the exterior of a carrier as it is transported from station to station during processing.

Process contaminants and contamination may be reduced by periodically washing and/or cleaning carriers. Typically, a carrier is cleaned of contaminants and contamination by placing it in a cleaning apparatus, which subjects the exterior and interior surfaces to a flood or spray of cleaning fluids. After the washing step, a considerable amount of fluid may remain on the carrier. This residual fluid is typically dried with a stream of dry gas or by centrifugal spinning.

Carriers often have intricate arrangements of surfaces that are difficult to dry. In addition, a residual amount of the cleaning fluid may adhere to the surfaces of a carrier as a film or in a multiplicity of small droplets after the washing step. Any contaminants suspended in the residual cleaning fluid may be redeposited on the surface as the fluid dries, leading to contaminant carryover when the carrier is reused. Consequently, process efficiency and effectiveness is diminished overall.

Drainable surfaces are of special interest in commercial and industrial applications for a number of reasons. In nearly any process where a liquid must be dried from a surface, significant efficiencies result if the surface sheds the liquid without heating or extensive drying time. Often an appliance has a desired orientation for drying such that fluids are not retained in cavities or low spots due to the influence of gravity.

It is now well known that surface roughness has a significant effect on the degree of surface wetting. It has been generally observed that, under some circumstances, roughness can cause liquid to adhere more strongly to the surface than to a corresponding smooth surface. Under other circumstances, however, roughness may cause the liquid to adhere less strongly to the rough surface than the smooth surface. In some circumstances, surface roughness may cause the surface to demonstrate directionally biased wetting.

Efforts have been made previously at introducing intentional roughness on a surface to produce an ultraphobic surface. The roughened surface generally takes the form of a substrate member with a multiplicity of microscale to nanoscale projections or cavities, referred to herein as “asperities”.

What is still needed in the industry is a carrier with features that promote more effective cleaning and drying of the carrier with reduced levels of residual process contamination.

### SUMMARY OF THE INVENTION

The present invention includes a carrier with anisotropic wetting surfaces for promoting more effective cleaning and drying of the carrier. In the invention, entire surfaces or portions of surfaces of a carrier are made to effect anisotropic wetting so that fluids flow off of the surface readily in a desired draining orientation. The anisotropic wetting surfaces of the carrier cause liquids that may come in contact with the surface, such as may be used in cleaning, to quickly and easily “roll off” without leaving a liquid film or substantial number of liquid droplets. As a result, less time and energy is expended in drying the surfaces, and redeposited residue is minimized, thereby improving overall process quality. In addition, the anisotropic wetting surfaces may be resistant to initial deposition of contaminants, where the contaminants may be in liquid or vapor form.

In an embodiment of the invention, the anisotropic wetting surface includes a multiplicity of closely spaced asymmetric microscale to nanoscale asperities formed on a substrate. For the purpose of the present application, “microscale” generally refers to dimensions of less than 100 micrometers, and “nanoscale” generally refers to dimensions of less than 100 nanometers.

The invention is a carrier having a durable normophobic or ultraphobic surface that has anisotropic wetting qualities. That is, fluids will demonstrate a variable resistance to flow across the surface depending on the direction in which they flow. The anisotropic wetting surface generally includes a substrate portion with a multiplicity of projecting asymmetrical regularly shaped microscale or nanoscale asperities.

The asperities may be formed in or on the substrate material itself or in one or more layers of material disposed on the surface of the substrate. The asperities may be any regularly or irregularly shaped three dimensional solid or cavity and may be disposed in any regular geometric pattern or randomly.

Microscale asperities according to the invention may be formed using known molding and stamping methods by texturing the tooling of the mold or stamp used in the process. The processes could include injection molding, extrusion with a textured calendar roll, compression molding tool, or any other known tool or method that may be suitable for forming microscale asperities. Smaller scale asperities may be formed using photolithography, or using nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, or by disposing a layer of parallel carbon nanotubes on the substrate.

The creation of asymmetric asperities can directionally bias the retentiveness of a surface. This approach can be applied to flat surfaces as well as curved surfaces such as tubes or troughs. Directionally biased fluid retention can be incorporated into conventionally wetting surfaces as well as ultraphobic surfaces. The asymmetric features can be random or periodic in design. Periodic asperities may vary in two dimensions such as structured stripes, ridges, troughs or furrows. Periodic asperities may also vary in three dimensions such as posts, pyramids, cones or holes. The size, shape, spacing and angles of the asperities can be tailored to achieve a desired anisotropic wetting behavior.

Generally, anisotropic wetting qualities are effective with droplets on surfaces and slugs within tubes, troughs or channels. Surfaces having anisotropic wetting qualities can be used to ensure that small droplets of liquid drain fully from the surface or, alternately, can be used to help ensure that droplets are retained in areas where when they dry any contaminants are unlikely to cause harm.

### BRIEF DESCRIPTION OF THE DRAWINGS

FIG. 1 depicts a wetting angle formed where a droplet meets a surface;

FIG. 2 depicts examples of advancing contact angle and receding contact angle;

FIG. 3 depicts a sessile droplet on an incline plane;

FIG. 4 depicts a sessile droplet on a vertical surface;

FIG. 5 depicts a sessile droplet on a rotating platter;

FIG. 6 depicts a sessile droplet anchored to a surface by a retention force;

FIG. 7 depicts a slug within an inclined tube;

FIG. 8 depicts a slug acted on by an isostatic pressure;

FIG. 9 depicts a slug within an inclined tube also being acted on by an isostatic pressure;

FIG. 10 depicts a slug within a tube, an advancing and receding contact angle;

FIG. 11 depicts a sessile droplet on a smooth surface;

FIG. 12 depicts a sessile droplet on a rough surface;

FIG. 13 is a side elevational view of an exemplary symmetrical asperity;

FIG. 14 is a side elevational view of an exemplary symmetrical asperity and an exemplary asymmetrical asperity;

FIG. 15 is a cross sectional view of an exemplary surface with periodic asymmetric asperities that would be expected to demonstrate directionally biased wetting;

FIG. 16 is another cross sectional view of an exemplary surface with periodic asymmetric asperities that would be expected to demonstrate ultraphobic properties and directionally biased wetting;

FIG. 17 is a chart of calculated retentive forces for water slugs in PFA tubes;

FIG. 18 is a graph of retentive force ratio vs. first asperity rise angle for various second asperity rise angles where the difference between advancing contact angle and receding contact angle is fixed at ten degrees; and

FIG. 19 is a graph of retentive force ratio vs. first asperity rise angle for various differences between advancing contact angle and receding contact angle where the second asperity rise angle is fixed at ninety degrees

FIG. 20 is a perspective view of one embodiment of a carrier with anisotropic wetting surfaces thereon according to the present invention;

FIG. 21 is a perspective view of an alternative embodiment of a carrier with anisotropic wetting surfaces thereon according to the present invention;

FIG. 22 is a perspective view of another alternative embodiment of a carrier with anisotropic wetting surfaces thereon according to the present invention;

FIG. 23 is a perspective view of yet another alternative embodiment of a carrier with anisotropic wetting surfaces thereon according to the present invention;

### DETAILED DESCRIPTION OF THE PREFERRED EMBODIMENTS

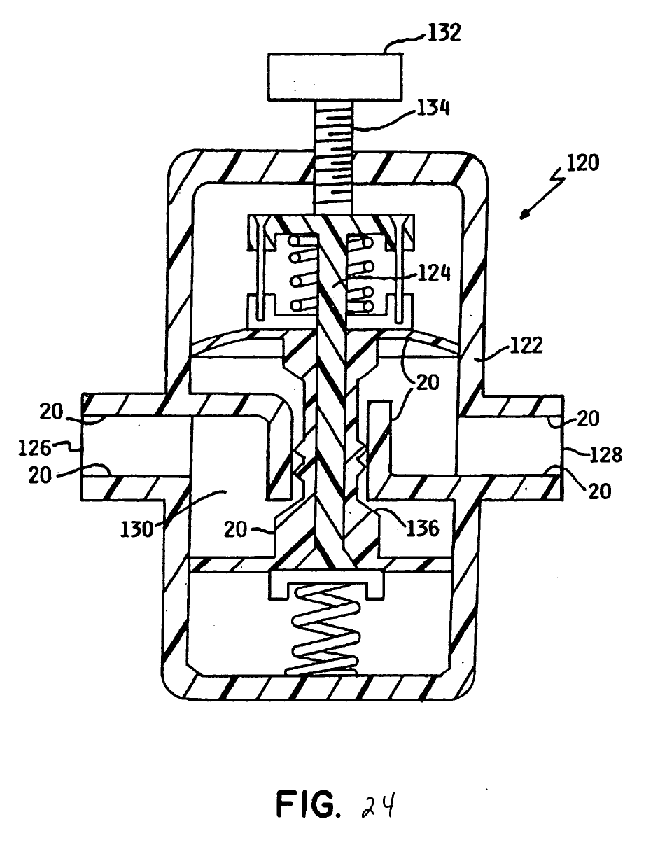

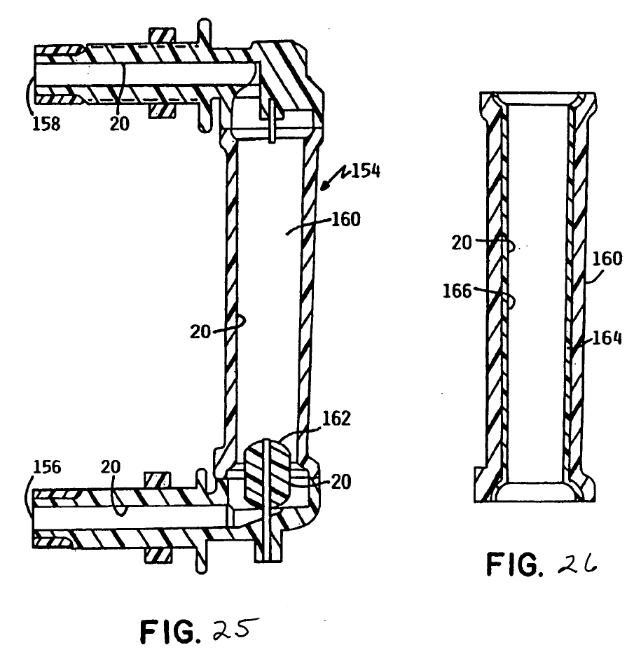

FIG. 20 depicts, in exemplary fashion, an embodiment of a carrier 112 according to the present invention. Carrier 112 generally includes a body portion 113 in the form of an enclosure 114, with a top 114a, a bottom 114b, a pair of opposing sides 114c, 114d, a back 114e, and an open front 114f. Open front 14fmay be selectively closable by means of a door 115. Within enclosure 114, one or more device support portions 116, in the form of wafer supports 117, are provided to support wafers in a parallel, spaced apart, relationship to each other. Carrier 112 may have other components or portions for facilitating its use in a process, such as for example, a kinematic coupling portion 118, and a robotic handling flange 119.

Anisotropic wetting surface 120 may be formed on the entire surface of carrier 112 or on any desired portion thereof. Thus, anisotropic wetting surfaces may be placed in critical locations of the carrier 112 while other portions have conventional surfaces. Anisotropic wetting surfaces 120 may be formed in any of a variety of configurations and using a variety of processes as described hereinbelow.

Various other embodiments of carriers are depicted in FIGS. 21-23. In each of these embodiments, anisotropic wetting surfaces 120 may be formed where desired on the carrier 112.

An enlarged view of exemplary directionally biased wetting surfaces 30 is depicted in FIGS. 15 and 16. A directionally biased wetting surface 30 generally includes substrate 32 and a multiplicity of projecting asperities 34.

Each asperity 34 in this example protrudes from substrate 32. Asperities 34 may also be indentations into substrate 32.

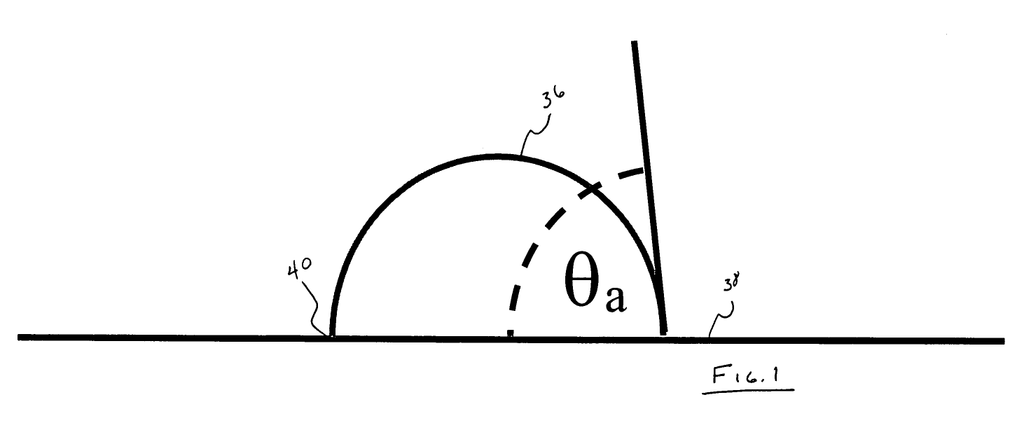

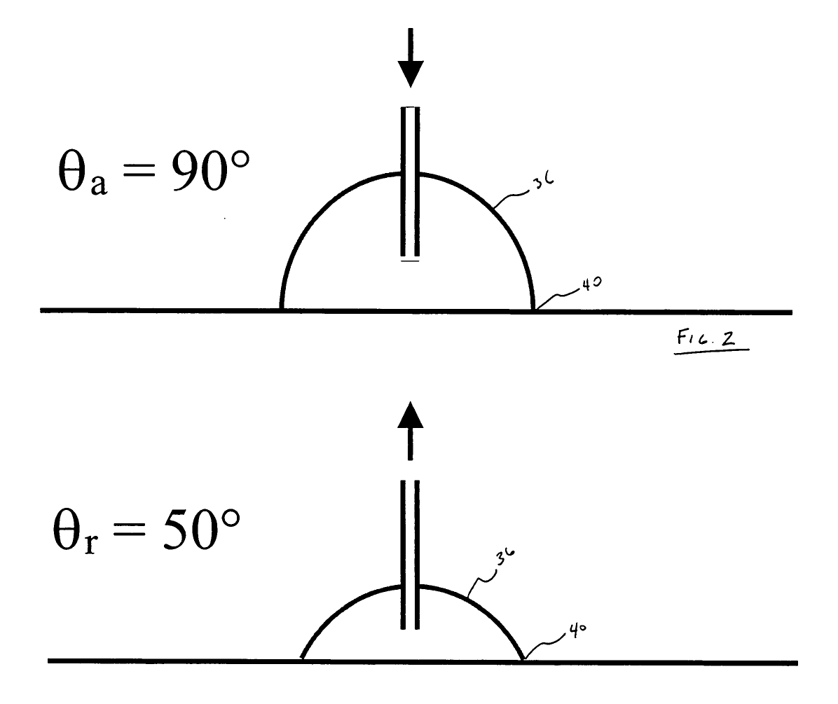

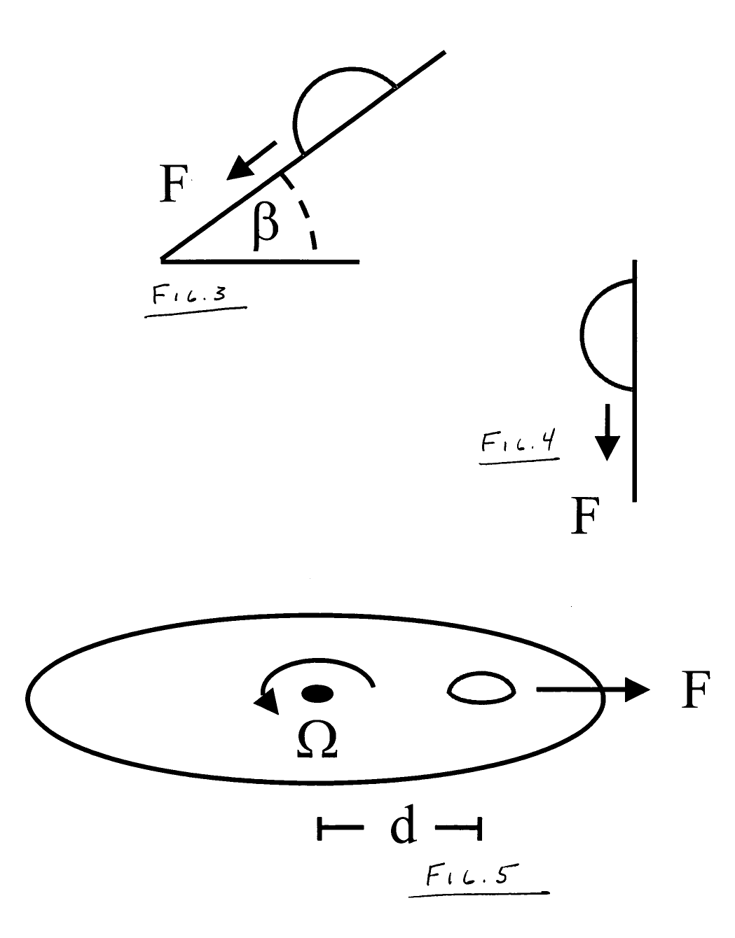

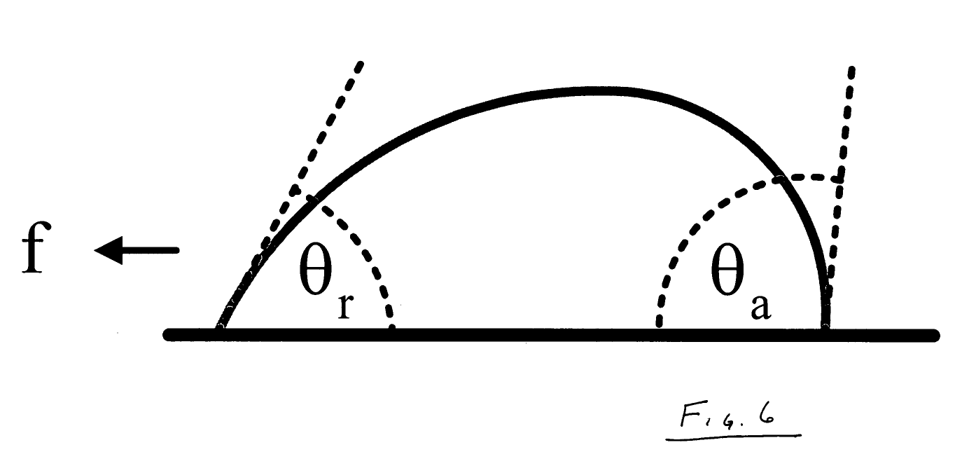

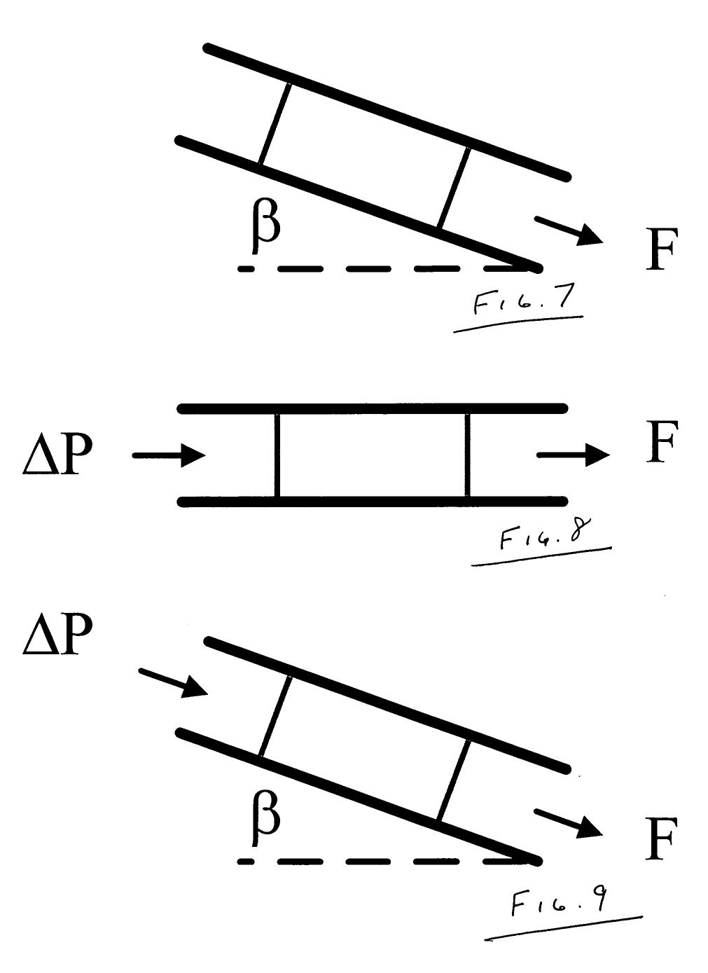

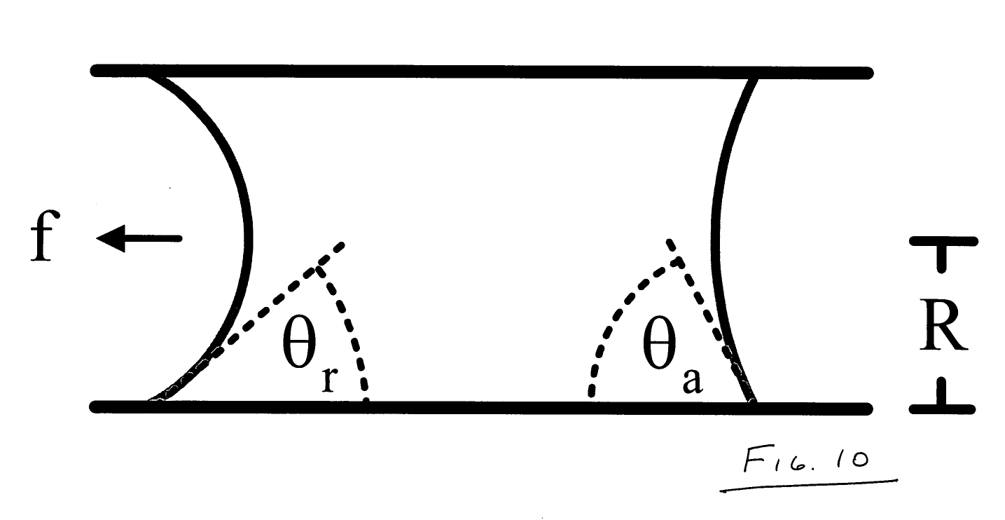

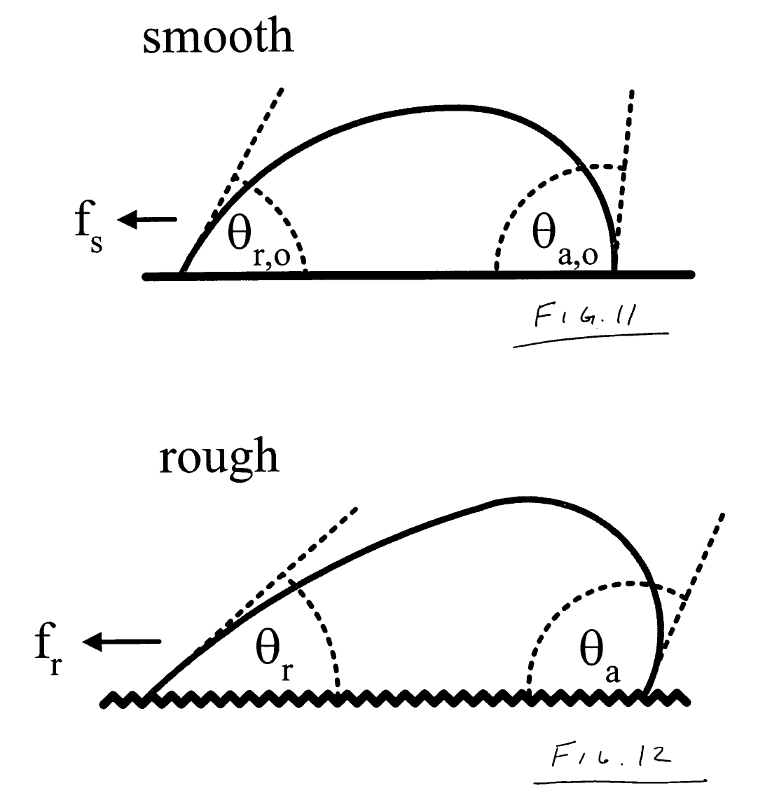

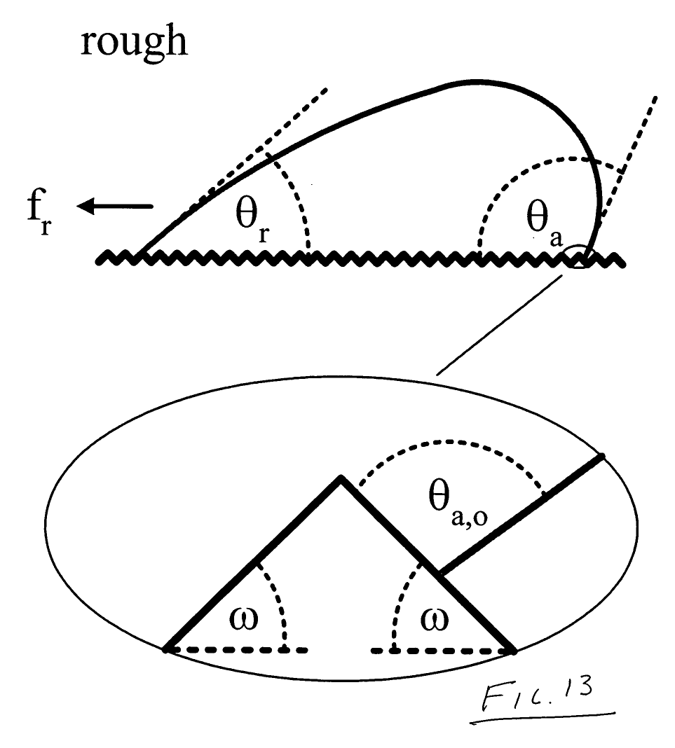

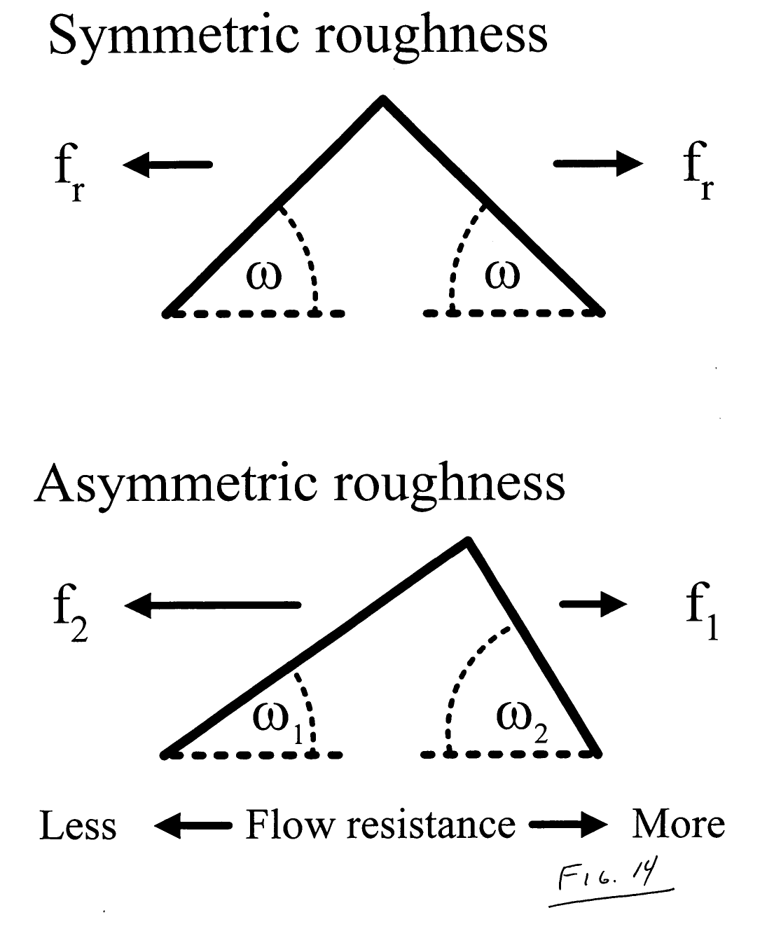

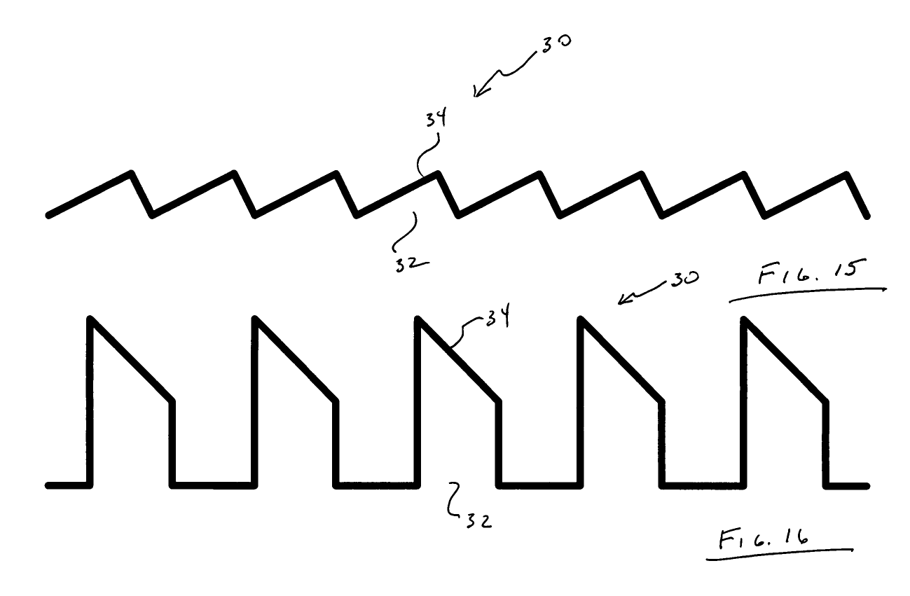

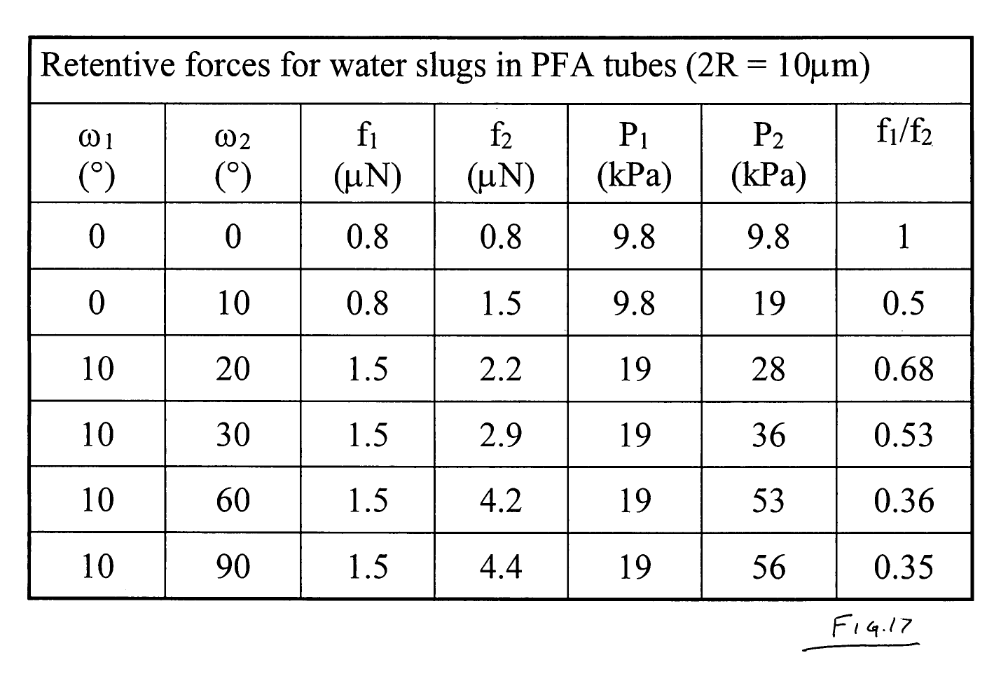

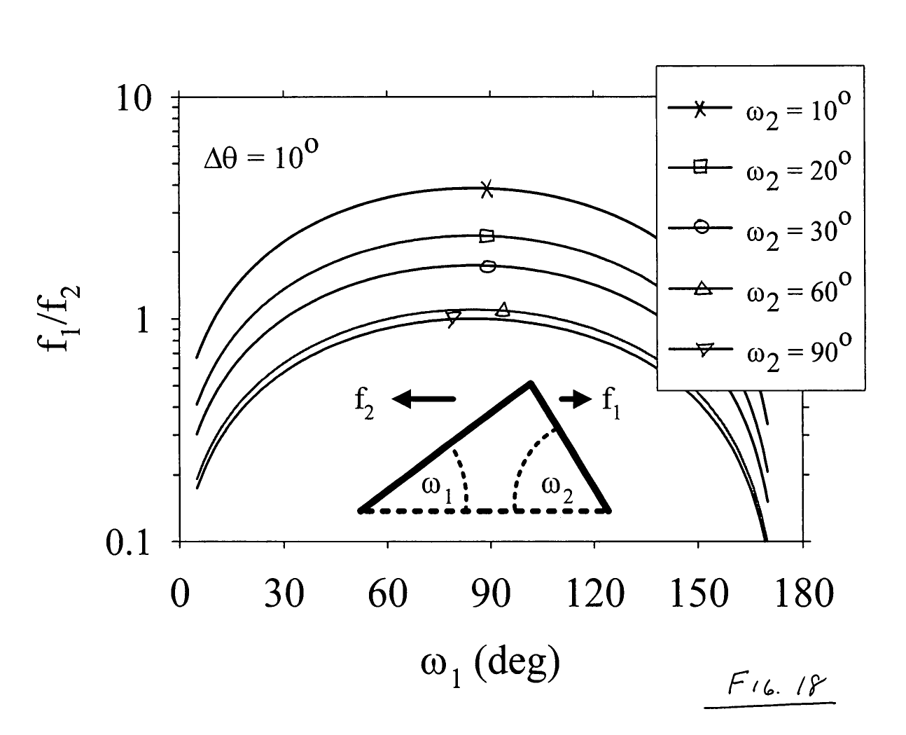

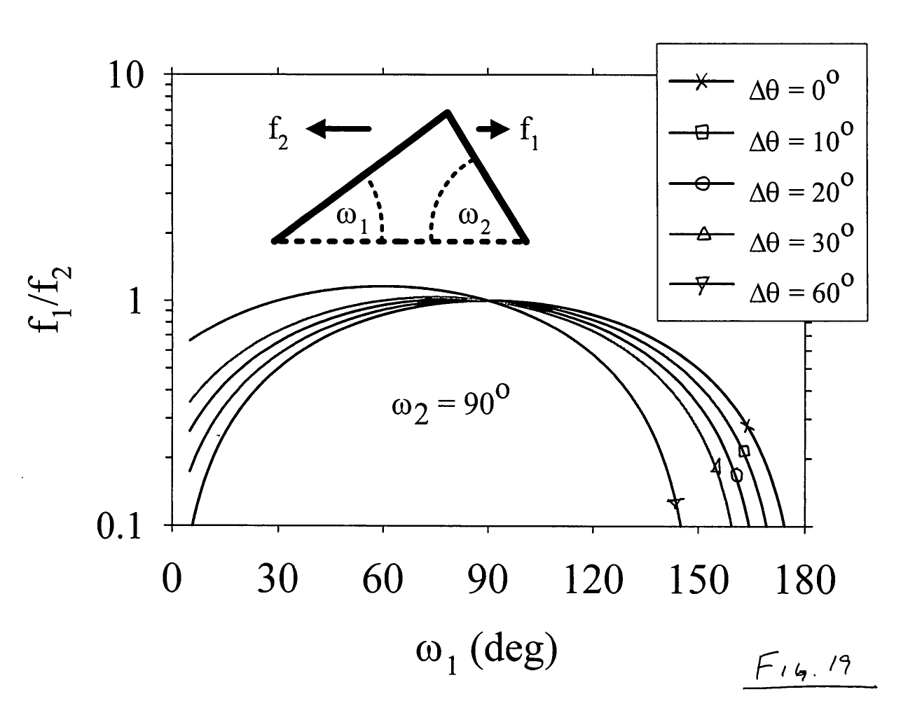

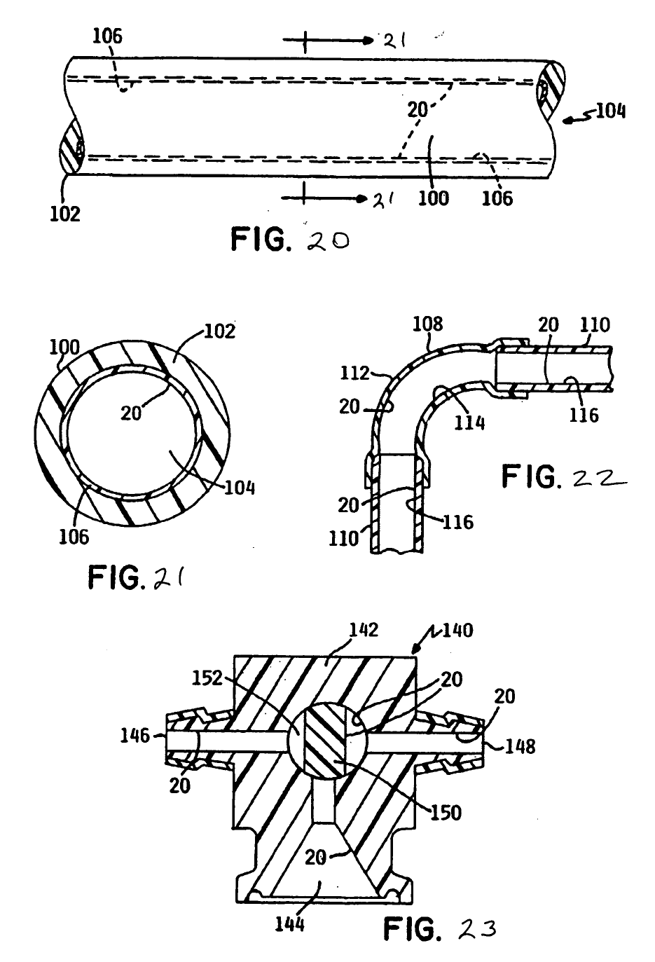

Referring to FIG. 1, a droplet 36 meets a surface 38 at a contact angle annotated θ. Contact angle is affected by hysteresis. When the contact line 40 between the droplet 36 and the surface 38 advances contact angle decreases. Referring to FIG. 2, when an example droplet 36 increases in size because fluid is added, the contact line 40 advances and the advancing contact angle θₐ is equal to about ninety degrees. When the example droplet 36 decreases in size, because fluid is removed, the contact line 40 recedes and the receding contact angle θr equals about fifty degrees. The receding contact angle θr is less than the advancing contact angle θa.

Hysteresis can be defined as:
Δθ=θₐ−θᵣ

Hysteresis is caused by molecular interactions, surface impurities, heterogeneities and surface roughness.

In order to better understand the present invention, it is helpful to consider the following cases: Retention of sessile drops by flat surfaces; retention of a liquid slug by a cylindrical tube; and wetted rough surfaces which demonstrate increased liquid-solid adhesion. Wetted rough surfaces include surfaces having symmetric roughness which generally demonstrate isotropic wetting and surfaces demonstrating asymmetric roughness which demonstrate directionally biased wetting.

For sessile drops, body forces, annotated F, are considered to be the forces acting on the sessile drops tending to cause it to move along a surface. Body forces may arise from gravity, centrifugal forces, pressure differences or other forces.

Referring to FIG. 3, a sessile droplet is depicted on an incline plane. For this situation body forces are defined by the equation,
F=ρgV·sin β
where
   ρ=density,
   g=the acceleration of gravity,
   V=the volume of the drop, and
   β=the angle of the incline plane.

Referring to FIG. 4, a sessile droplet on vertical surface is depicted. For this situation the acceleration of gravity act parallel to the surface and sin β equals one, so the body force
F=ρgV.

Referring to FIG. 5 for a sessile droplet on a rotating platter
F=ρVΩ²d,
where
   ρ=density,
   V=volume of the drop;
   Ω=angular velocity, and
   d=distance of the droplet from the center of rotation.

Referring to FIG. 6, for sessile drops, retention force, annotated f, anchors the sessile drop in position if the surface forces are greater than body forces. Retention force is defined by the equation:
f=kγR·Δ cos θ,
where
   γ=liquid surface tension,
   2R=drop width,
   k=4/π for circular drops, and
   k>4/π for elliptical drops, and
   Δcos=(cos θᵣ−cos θₐ).

Referring to FIG. 7, when considering the body forces affecting a cylindrical liquid slug in a tube, for an inclined tube, body forces
F=ρgV·sin β,
where
   ρ=density of the liquid,
   g=the acceleration of gravity,
   V=the volume of the slug, and
   β=angle of inclination.

Referring to FIG. 8, when considering the body forces affecting a cylindrical slug affected by isostatic pressure
F=AΔP=πR²ΔP,
where
   A=area,
   ΔP=differential isostatic pressure,
   R=radius of the cylindrical slug.

Referring to FIG. 9, when a slug is acted on by a combination of isostatic pressure and gravity in an inclined tube
F=ρgV·sin β+πR²ΔP.

Now, referring to FIG. 10, retention force (f) anchors a slug in position if surface forces are greater than body forces.
f=kγR·Δ cos θ,
where
   γ=liquid surface tension,
   R=drop/tube radius,
   k=2π for slugs,
   Δ cos θ=(cos θᵣ−cos θₐ). To summarize, retention force
      f=kγR·Δ cos θ
where
   k=4/π for sessile drops
   k=2π for slugs,
   γ=liquid surface tension,
   R=drops/tube radius,
   Δ cos θ=(cos θᵣ−cos θₐ).

Now, referring to FIGS. 11 and 12, we consider the effect of surface roughness on adhesion or retention of droplets. As can be seen in FIG. 12, when a droplet is placed on a rough surface, the liquid of the droplet is impaled by the asperities 34 on the surface. Because of the interaction of the asperities 34 with the contact line 40, the advancing contact angle intermittently increases as compared to a flat surface and the receding contact angle intermittently decreases as compared to a flat surface. Thus, the force to move the drops along a rough surface is much greater than for a corresponding smooth surface.

For rough surfaces one can consider the geometric interaction of the droplet with the asperities 34 in the following equations.
θₐ=θₐ,0+ω,
θᵣ=θ_{r,0}−ω.

Thus, for smooth surfaces, the retention force
fₛ=kγR(cos θ_{r,0}−cos θ_{a,0}).

For rough surfaces, the retention force
fᵣ=kγR[ cos(θ_{r,0}−ω)−cos(θ_{a,0}+ω)].

Referring to FIG. 13, it is then possible to compare the retentive forces of comparable rough surfaces and smooth surfaces. For example, we will assume a small Sessile water drop on a surface of formed from PFA or PTFE where
k=4/π, γ=72 mN/m,
2R=2 mm,
θ_{a,0}=110°,
θ_{r,0}=90°

and we will consider the variation in roughness (ω). Referring to FIG. 17, it can be seen that retention force fₛ for a smooth surface is substantially less than the retention force fᵣ for rough surfaces. In addition, with increasing values of ω, the retention force increases dramatically.

Thus, symmetric roughness leads to isotropic wetting because the value of fᵣ is equal in symmetric directions.

Referring to FIG. 14, asymmetric roughness can be shown to cause directionally biased wetting. This is also known as anisotropic wetting. Anisotropic wetting occurs because of the difference in retentive force created by asymmetric roughness:
f₁−f₂=kγR[ cos(θ_{r,0}−ω₁)−cos(θ_{a,0}+ω₁)−cos(θ_{r,0}−ω₁)+cos(θ_{a,0}+ω₁)].

Thus, it is possible to calculate a retentive force ratio (f₁/f₂) caused by asymmetric roughness.
f₁/f₂=sin(ω₁+1/2Δθ₀)/sin(ω₂+1/2Δθ₀),
where
   Δθ₀=(θ_{a,0}−θ_{r,0}).

Thus, it is possible to compare the retentive forces on drops caused by asymmetric roughness. For this example we will assume a small sessile water drop on a PFA or PTFE surface. In this case k=4/π, y=72 mN/m, 2R=2 mm, θ_{a,0}=100°, θ_{r,0}=90° and we will vary the values of ω1 and ω2. The results of this calculation can be found in a table at FIG. 18.

Referring to FIG. 18, it can be seen that the ratio of f₁/f₂ varies considerable from a smooth surface and for surfaces of various roughnesses.

It is also possible to compare the retentive forces related to slugs in a cylindrical tube. For this example we will assume a small water slug in PFA tube wherein
k=2π,
γ=72 mN/m,
2R=10 μm,
θ_{a,0}=100°,
θ_{r,0}=90°.

When we vary the values of ω₁ and ω₂. The results of this calculation can be seen in the table depicted in FIG. 17.

When these results are graphed, referring to FIG. 18, it can be seen that the quotient of f₁, divide by f₂ varies with changes in ω1 reaching a maximum at about ninety degrees and declining as ω₁ approaches zero and one hundred eighty degrees.

In addition, referring to FIG. 19, results can be seen when Δθ is varied the second asperity rise angle is fixed.

This understanding can be applied to the manufacture of carriers as described above. It is often desirable that when liquids are emptied from a carrier that all fluid consistently exit the carrier to avoid retention of fluids that may contaminate the carrier. It can be seen that the above-discussed mathematical relationships can be utilized to design a surface profile that includes asymmetric asperities that will minimize retention forces that tend to retain droplets or slugs within the carrier in a chosen orientation to facilitate drainage and drying.

Alternately, it may be desirable to design a carrier that has maximized retention force in a certain orientation. Here an anisotropic wetting surface may be designed to retain droplets or slugs in portions of the carrier that isolate contaminants away from carried items where they can do no harm.

Generally, the substrate material from which the fluid handling device is made may be any material upon which micro or nano scale asperities may be suitably formed. The asperities may be formed directly in the substrate material itself, or in one or more layers of other material deposited on the substrate material, by photolithography or any of a variety of suitable methods. Microscale asperities according to the invention may be formed using known molding and stamping methods by texturing the tooling of the mold or stamp used in the process. The processes could include injection molding, extrusion with a textured calendar roll, compression molding tool, or any other known tool or method that may be suitable for forming microscale asperities.

Other methods that may be suitable for forming smaller scale asperities of the desired shape and spacing include nanomachining as disclosed in U.S. Patent Application Publication No. 2002/00334879, microstamping as disclosed in U.S. Pat. No. 5,725,788, microcontact printing as disclosed in U.S. Pat. No. 5,900,160, self-assembled metal colloid monolayers, as disclosed in U.S. Pat. No. 5,609,907, microstamping as disclosed in U.S. Pat. No. 6,444,254, atomic force microscopy nanomachining as disclosed in U.S. Pat. No. 5,252,835, nanomachining as disclosed in U.S. Pat. No. 6,403,388, sol-gel molding as disclosed in U.S. Pat. No. 6,530,554, self-assembled monolayer directed patterning of surfaces, as disclosed in U.S. Pat. No. 6,518,168, chemical etching as disclosed in U.S. Pat. No. 6,541,389, or sol-gel stamping as disclosed in U.S. Patent Application Publication No. 2003/0047822, all of which are hereby fully incorporated herein by reference. Carbon nanotube structures may also be usable to form the desired asperity geometries. Examples of carbon nanotube structures are disclosed in U.S. Patent Application Publication Nos. 2002/0098135 and 2002/0136683, also hereby fully incorporated herein by reference. Also, suitable asperity structures may be formed using known methods of printing with colloidal inks. Of course, it will be appreciated that any other method by which micro/nanoscale asperities may be accurately formed may also be used. A photolithography method that may be suitable for forming micro or nano scale asperities is disclosed in PCT Patent Application Publication WO 02/084340, hereby fully incorporated herein by reference.

Anisotropic wetting surface principals can be applied to ultraphobic surfaces as well. ultra phobic wetting surface are described in the following U.S. Patents and U.S. Patent Applications which are incorporated in their entirety by reference. U.S. Patent Applications Ser No. 10/824,340; 10/837,241; 10/454,743; 10/454,740 and U.S. Pat. No. 6,845,788. The disclosures of the above referenced Applications and Patent can be utilized along with the present application to design surface that demonstrate both and anisotropic wetting and ultraphobic properties.

The present invention may be embodied in other specific forms without departing from the central attributes thereof, therefore, the illustrated embodiments should be considered in all respects as illustrative and not restrictive, reference being made to the appended claims rather than the foregoing description to indicate the scope of the invention.

What is claimed is:

1. A carrier for articles comprising:
a body having a substrate portion with a surface, at least a portion of said surface having a multiplicity of substantially uniformly shaped asperities thereon to form an ultraphobic surface, each asperity having a first asperity rise angle and a second asperity rise angle relative to the substrate, the asperities being structured to meet a desired retentive force ratio (f₁/f₂) caused by asymmetry between the first asperity rise angle and the second asperity rise angle according to the formula:
f₁/f₂=sin(ω₁+1/2Δθ₀)/sin(ω₂+1/2Δθ₀), Δθ₀=(θ_{a,0}−θ_{r,0}).
where ω₁ is the first asperity rise angle in degrees;
ω₂ is the second asperity rise angle in degrees;
Δθ0=(θ_{a,0}−θ_{r,0});
θ_{a,0} is the advancing contact angle in degrees; and
θ_{r,0} is the receding contact angle in degrees.

2. The carrier of claim 1, wherein the asperities are projections.

3. The carrier of claim 2, wherein the asperities are polyhedrally shaped.

4. The carrier of claim 2, wherein the asperities are cylindrical or cylindroidally shaped.

5. The carrier of claim 1, wherein the asperities are cavities formed in the substrate.

6. The carrier of claim 1, wherein the asperities are positioned in a substantially uniform array.

7. The carrier of claim 6, wherein the asperities are positioned in a rectangular array.

9. A process of making a carrier with an anisotropic wetting surface portion, the process comprising:
providing a carrier including a substrate having an outer surface; and
forming a multiplicity of substantially uniformly shaped asperities on the outer surface of the substrate, each asperity having a first asperity rise angle and a second asperity rise angle relative to the substrate, the asperities being structured to meet a desired retentive force ratio (f₁/f₂) caused by asymmetry between the first asperity rise angle and the second asperity rise angle according to the formula:
f₁/f₂=sin(ω₁+1/2Δθ₀)/sin(ω₂+1/2Δθ₀), Δθ₀=(θ_{a,0}−θ_{r,0}).
where ω₁ is the first asperity rise angle in degrees;
ω₂ is the second asperity rise angle in degrees;
Δθ0=(θ_{a,0}−θ_{r,0});
θ_{a,0} is the advancing contact angle in degrees; and
θ_{r,0} is the receding contact angle in degrees.

10. The process of claim 9, wherein the asperities are formed by photolithography.

11. The process of claim 9, wherein the asperities are formed by a process selected from the group consisting of nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, and disposing a layer of parallel carbon nanotubes on the substrate.

12. The process of claim 9, further comprising the step of selecting a geometrical shape for the asperities.

13. The process of claim 9, further comprising the step of selecting an array pattern for the asperities.

14. A process of making a carrier with an anisotropic wetting surface portion, the process comprising:
providing a carrier including a substrate having an outer surface; and
forming a multiplicity of substantially uniformly shaped asperities on the outer surface of the substrate, each asperity having a first asperity rise angle and a second asperity rise angle relative to the substrate, the asperities being structured to meet a desired retentive force ratio (f₁/f₂) caused by asymmetry between the first asperity rise angle and the second asperity rise angle according to the formula:
f₁/f₂=sin(ω₁+1/2Δθ₀)/sin(ω₂+1/2Δθ₀), Δθ₀=(θ_{a,0}−θ_{r,0}).
where ω₁ is the first asperity rise angle in degrees;
ω₂ is the second asperity rise angle in degrees;
Δθ0=(θ_{a,0}−θ_{r,0});
θ_{a,0} is the advancing contact angle in degrees; and
θ_{r,0} is the receding contact angle in degrees.

15. The process of claim 14, wherein the asperities are formed by photolithography.

16. The process of claim 14, wherein the asperities are formed by a process selected from the group consisting of nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, and disposing a layer of parallel carbon nanotubes on the substrate.

17. The process of claim 14, further comprising the step of selecting a geometrical shape for the asperities.

18. The process of claim 14, further comprising the step of selecting an array pattern for the asperities.
